(19) United States
(12) Patent Application Publication
(10) Pub. No.: US 2025/0345961 A1
(43) Pub. Date: Nov. 13, 2025

(54) Food Processing System for Cutting a Food Product into Portions

(71) Applicant: THURNE-MIDDLEBY LTD, Norwich Norfolk (GB)

(72) Inventors: James Paul WAKEFIELD, Norwich Norfolk (GB); Jacob Mark WIGGETT, Norwich Norfolk (GB)

(21) Appl. No.: 19/201,489

(22) Filed: May 7, 2025

(30) Foreign Application Priority Data
May 9, 2024 (GB) 2406463.6

(51) Int. Cl. B26D 5/20; A22C 17/00; B26D 5/00; B26D 7/01; B26D 7/06

(52) U.S. Cl. CPC B26D 5/20; B26D 7/018; B26D 7/0683; A22C 17/002; B26D 5/007; B26D 2007/011; B26D 2007/013; B26D 2210/02

(57) ABSTRACT

A food processing system (2) for cutting a food product into portions includes a product engaging component (19, 21, 102) configured to engage an upper surface of a food product lying on a support surface (12, 106) in the system, and an electronic position sensor configured to generate a position signal dependent on the height of the product engaging component above the support surface. An electronic controller (5) is configured to receive the position signal and to control the engagement height of an end gripper (30) using an end gripper positioning assembly (16) with reference to the position signal.

### CROSS-REFERENCE TO RELATED APPLICATIONS

This application claims priority from United Kingdom Patent Application No. GB 2406463.6, filed on May 9, 2024, the entirety of which is hereby incorporated by reference herein.

### FIELD OF THE DISCLOSURE

The present disclosure relates to a food processing machine and a method of cutting slices or portions from a food product in a food processing machine. More particularly, it concerns the feeding of a food product towards the cutter of such a machine.

### BACKGROUND TO THE DISCLOSURE

It is known to feed food products such as meat towards a cutting region in a food processing machine using feed conveyors. The food product, which may be in the form of a loaf, log or block for example, is fed incrementally towards the cutting region, where slices or portions of a desired size are cut from a leading end of the food product.

An end gripper may be used to hold onto a trailing end of the food product as it moves through the machine, towards and through the cutting region. This provides additional control over the position and orientation of the product which can be particularly desirable as the last few portions are cut from the food product. By this stage the product log will be relatively short, with reduced surface areas in contact with feed conveyors located alongside the food product, making it more difficult for the feed conveyors to control reliably the position of the food product.

### SUMMARY OF THE DISCLOSURE

The present disclosure provides a food processing system for cutting a food product into portions, the system comprising:
a cutter configured to cut portions from a leading end of an elongate food product;
a transport system configured to transport a food product along a product flow path to the cutter, wherein the transport system comprises an end gripper configured to grip a trailing end of a food product lying on a product support in the flow path, and an end gripper positioning assembly configured to control the location of the end gripper and bring the end gripper into engagement with a food product at an engagement height above the product support;
a product engaging component configured to engage an upper surface of a food product lying on a support surface in the system;
an electronic position sensor configured to generate a position signal dependent on the height of the product engaging component above the support surface; and
an electronic controller configured to receive the position signal and to control the engagement height of the end gripper using the end gripper positioning assembly with reference to the position signal.

In this system, direct physical contact between the product engaging component and a food product may be used to give a precise measure of the height of the food product. This parameter can then be used by the electronic controller to determine the height at which the end gripper is brought into engagement with a trailing end of the food product.

This approach may be particularly beneficial when handling naturally formed food products having variable dimensions and shapes. According to the present disclosure, the gripper height may be adjusted for each product type, or from product to product, in order to optimise its height and obtain an improved hold and therefore control of the food product. This in turn improves the accuracy of cutting of the last few slices or portions from the food product, thereby increasing the yield of acceptable portions from each product. The system may as a result be more versatile and more able to handle variations between products.

The transport system may include one or more product conveyors together with the end gripper. It will be appreciated that suitable product conveyors may be in the form of conveyor belts, toothed tracks, chains or rollers, for example.

The electronic position sensor may be a sensor specifically provided for the function of generating a position signal dependent on the height of the product engaging component above the support surface. Alternatively, the sensor may be embodied by a transducer within a device which is responsive to the position of the product engaging component. For example, a servomotor which is used to control the position of the product engaging component may include a position encoder in its servo system which can act as the electronic position sensor for generating the position signal used to control the height of the end gripper.

The product engaging component may engage with an upper surface of the food product whilst it is lying on a support surface upstream of the location where the product is engaged by the end gripper. Alternatively, the product engaging component may engage with an upper surface of the food product whilst it is lying on the same support surface as the surface on which it is located when engaged by the end gripper. In this case, the support surface referred to herein may be provided by the product support.

The product engaging component may be in the form of a dedicated probe contacting an upper surface of a food product. Alternatively, the product engaging component may be part of another structure of the system which also performs another function, such as guiding or forming the food product, for example.

In one example, the product engaging component is a guide member located above the support surface to guide the food product as it travels along the product flow path towards the cutter.

The electronic controller may be configured to bring the end gripper into engagement with the food product whilst the product engaging component is in engagement with the food product. The dimensions and/or shape of a food product may vary as it travels through a food processing system, for example as forces are exerted on the food product or the food product may relax its shape to some extent when forces are removed. Forces exerted on the food product by the product engaging component may themselves distort the shape of the food product to some extent, which may cause the height of the food product to be reduced. Bringing the end gripper into engagement with the food product whilst it is also engaged by the product engaging component ensures that the end gripper height can be determined on the basis of the current height of the food product, providing more accurate positional control.

In another example, the product engaging component is a die of a forming module of the system, and the die is employed in the forming module to engage an upper surface of a food product in order to change the shape of the food product. The end gripper may be brought into engagement with the food product before or after it has been ejected from the forming module. The determination of the engagement height of the end gripper by the electronic controller in response to the position signal may include an adjustment allowing for some relaxation of the product after it has left the forming module. For example, the controller may adjust the engagement height by applying an adjustment factor or coefficient corresponding to the expected height increase of a given product type as it relaxes. Alternatively, in a system where a product is scanned after it has left the forming module, data generated by the scan may be used to adjust the engagement height for the end gripper determined by the electronic controller in response to the position signal. This may enable the engagement height adjustment to be made on a product by product basis.

In a further variation, the product engaging component may be a drive belt or track of the system.

The electronic controller may be configured to set the engagement height to be such that a region of a food product engaged by the end gripper is unequally spaced from the upper and lower surfaces of the food product. For example, it may be beneficial for the end gripper to be disposed closer to the upper surface of a food product in a system where the cutter starts each cut through the product at its upper surface. If the end gripper is located closer to the upper surface, it may be able to better resist forces exerted on the food product by the cutter and so more accurately maintain the desired location of the food product during the cut. This in turn provides closer control over the shape of the portion cut from the food product, particularly towards the trailing end of the food product.

In some examples of systems according to the present disclosure, the food products may be centred laterally with regard to a central reference line of the product flow path. In such an arrangement, the end gripper positioning assembly does not need to facilitate lateral adjustment of the location at which the end gripper engages the product as the lateral location of each product will be consistent. Alternatively, in other implementations, the end gripper positioning assembly may facilitate lateral adjustment of the end gripper position relative to the central reference line of the product flow path in order to accommodate variations in the lateral location of each product.

The end gripper may be carried by the end gripper positioning assembly. This assembly may include electrical, hydraulic and/or pneumatic drives or actuators operable to control the location of the end gripper.

The end gripper positioning assembly may comprise an actuator configured to adjust the height of the end gripper under the control of the electronic controller.

In some examples, the end gripper positioning assembly may include a carriage mounted on at least one guide or rail, with the carriage movable between first and second locations on the guide, such that when the carriage is at the first location, the end gripper is spaced laterally from the product flow path, and when the carriage is at the second location, the end gripper is in the product flow path. The actuator may be carried by the carriage. When the carriage is at the first location, the carriage may be spaced horizontally from the product flow path.

In other examples, the end gripper may be mounted on a pivotable arm operable to move the end gripper in and out of the product flow path. Other implementations may include an end gripper positioning assembly which moves the end gripper along a path in line with the product flow path without the ability to retract the end gripper laterally out of the product flow path.

The end gripper may be a vacuum gripper, for example. Alternatively, a gripper which engages the food product with teeth or claws may be used. Use of a vacuum-type gripper may be beneficial as it avoids damage to the end of the food product, which is associated with claw-type grippers that penetrate the surface of the food product in order to grip it. A system according to the present disclosure may be particularly advantageous when using a vacuum gripper, as such a gripper may require more accurate control of the gripper height to ensure that the vacuum gripper forms a reliable seal against the surface of the food product.

The present disclosure also provides a method of operating a food processing system for cutting a food product into portions, wherein the system includes an end gripper configured to grip a trailing end of a food product lying on a product support, the method comprising the steps of:
bringing a product engaging component into engagement with an upper surface of a food product lying on a support surface of the system;
detecting the height of the product engagement component above the support surface and generating a position signal dependent on the detected height;
receiving the position signal in an electronic controller; and
controlling with the electronic controller the engagement height of the end gripper above the product support at which the end gripper is brought into engagement with a food product with reference to the position signal.

In addition, the present disclosure provides a method of operating a food processing system as described herein, the method comprising the steps of:
bringing the product engaging component into engagement with an upper surface of a food product lying on the support surface of the system;
detecting the height of the product engagement component above the support surface and generating a position signal dependent on the detected height; and
adjusting the engagement height of the end gripper using the end gripper positioning assembly with reference to the position signal.

### BRIEF DESCRIPTION OF THE DRAWINGS

Examples of the present disclosure will now be described with reference to the accompanying schematic drawings, wherein:

FIG. 1 is a side view of a food processing system according to an example of the present disclosure;

FIG. 2 is a perspective view of an end gripper and end gripper positioning assembly according to an example of the present disclosure;

FIGS. 3 to 5 are perspective views of part of the system shown in FIG. 1, at successive stages in the motion of the end gripper during a cutting process;

FIGS. 6 and 7 are end views of the system of FIG. 1, with the end gripper located to one side of, and in line with, the product flow path;
FIG. 8 is an enlarged view of the end gripper in the location shown in FIG. 7;

FIGS. 9 to 12 are diagrams illustrating positioning of an end gripper relative to a food product; and

FIG. 13 is a perspective the product forming module of the system shown in FIG. 1.

### DETAILED DESCRIPTION

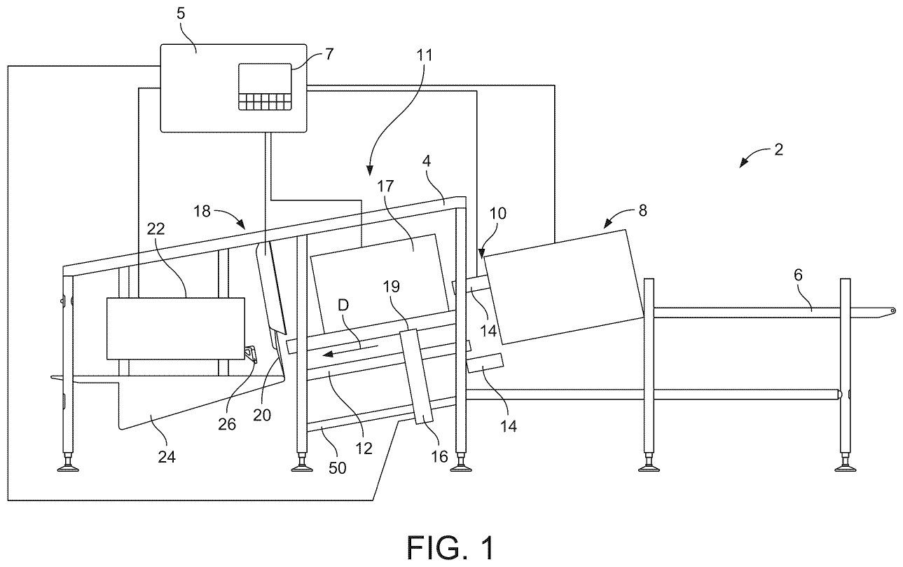

FIG. 1 shows a food processing system 2 having a machine base in the form of a rigid base framework 4. The operation of the processing system is governed by a “human-machine interface” or “HMI” in the form of an electronic control system 5 which is communicatively coupled to components of the machine. The control system includes a user interface 7 to enable an operator to input control parameters and commands.

Food products to be processed by the machine are loaded consecutively onto a horizontal pre-feed conveyor 6. The food products are then passed by the pre-feed conveyor to a forming module 8. The path of the food products through the forming module 8 is inclined downwardly in a direction away from the pre-feed conveyor. The forming module 8 is arranged to change the shape of a food product, as will be described in more detail below.

The food products then move from the forming module 8 into a transport system 11 for feeding the food products towards a cutter 18. The transport system includes a feed conveyor 12. A scanning region 10 is located between the forming module 8 and the feed conveyor 12. The scanning region includes two or more scanning devices 14 which are configured to detect the transverse cross-sectional shape of the food product as it passes through the region. For example, each scanning device may include a light source for projecting a line of light across the product which is detectable by a camera of the scanning device.

An end gripper positioning assembly 16 is provided for bringing an end gripper (not shown) into engagement with a trailing end of a food product carried by the feed conveyor 12. The end gripper, end gripper positioning assembly and feed conveyor cooperate to form a feeder for feeding each food product in a feed direction “D” towards the cutter 18. As the food product travels from the forming module towards the cutter, it is also engaged by a product control assembly 17 of the transport system 11. The food product is constrained laterally by a pair of side guides 19 of the product control assembly, which exert forces on respective sides of the food product. A product control assembly of this form is described in a co-pending UK patent application no. 2300514.3 (publication no. 2618405), and related PCT application no. PCT/GB2023/050979, filed on 12 Apr. 2023, and nationalised in the US as U.S. patent application Ser. No. 18/850,318 on Sep. 24, 2024, filed by the present applicant, the contents of which applications are fully incorporated by reference herein.

The cutter includes a blade 20. The blade 20 may be in the form of an orbitally-mounted circular blade, an involute blade or a sickle-shaped knife blade, for example.

A portion thickness control assembly 22 is provided downstream of the cutter 18. It includes a product stop 26 which is operable to control the thickness of the slices or portions cut from a food product. The product stop is able to reciprocate between advanced and retracted positions. In operation of the machine, the advanced position of the product stop determines the extent to which the food product extends beyond the cutting plane and therefore the thickness of the next slice or portion to be cut from the food product. After cutting of the next slice or portion has started, the product stop is moved to its retracted position to allow the slice or portion to fall freely away from the end of the food product. A portion thickness control assembly of this form is described in a co-pending UK patent application no. 2205487.8 (publication no. 2617592), and related PCT application no. PCT/GB2023/050978, filed on 12 Apr. 2023, and nationalised in the US as U.S. patent application Ser. No. 18/843,049 on Aug. 30, 202,4 filed by the present applicant, the contents of which applications are fully incorporated by reference herein.

A jump conveyor and stacker assembly 24 is located below the portion thickness control assembly. Slices or portions cut from a food product by the cutter fall onto the assembly 24 which is operable to arrange consecutive slices or portions in a desired configuration, such as groups, or vertical or shingled stacks, for example. The assembly 24 conveys the slices or portions towards a packaging station (not shown).

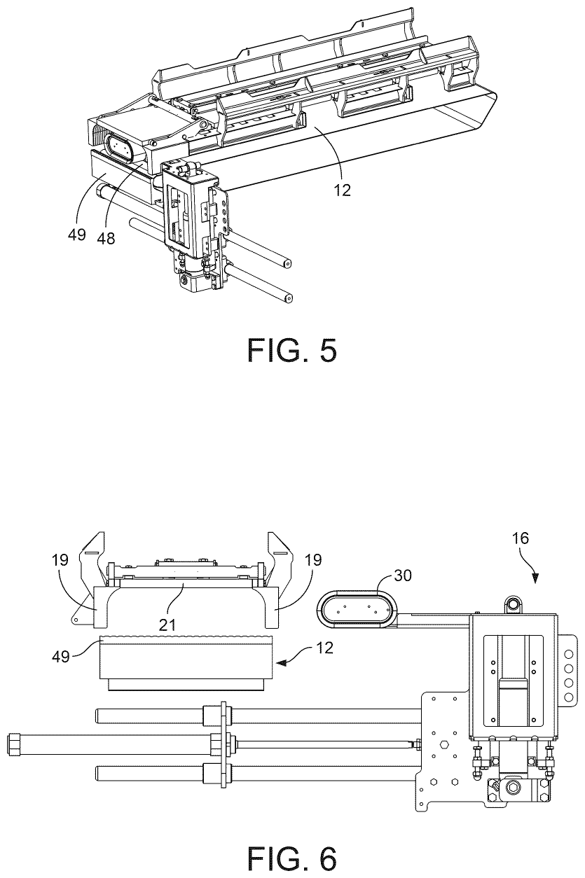

An elongate food product log may be constrained laterally by the forming module as it is moved out of the module by maintaining shaping surfaces of the module in contact with the food product. In particular, a centre line of the food product log may be aligned laterally with a central reference line (labelled 44 in FIG. 3) of the flow path. The leading end of the food product log may be contacted and constrained laterally by the side guides 19 of the product control assembly before its trailing end has left the lateral constraint of the forming module. The side guides may then continue to constrain the food product laterally as it moves towards and past the blade 20.

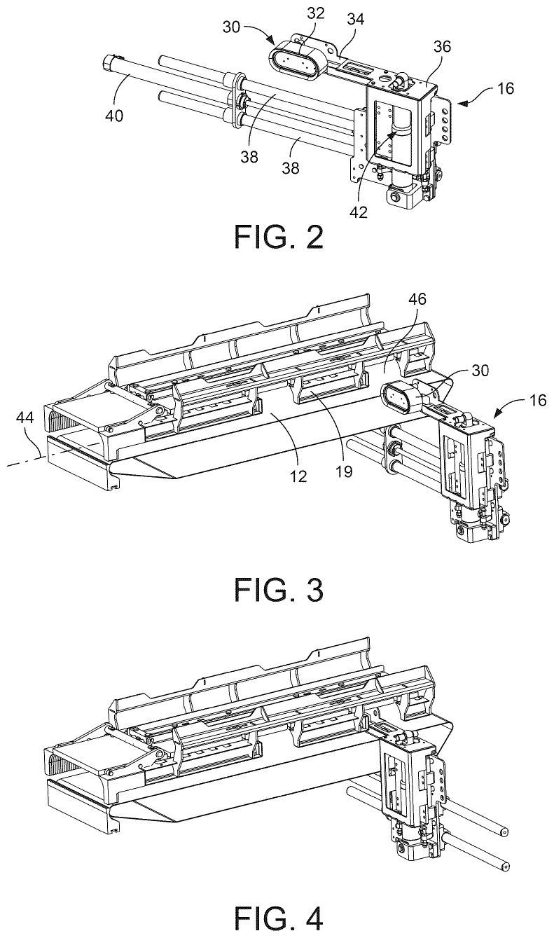

An example an end gripper and an end gripper positioning assembly in combination according to an example of the present disclosure will now be described with reference to FIG. 2. In this example, the end gripper is in the form of a vacuum gripper 30. The vacuum gripper includes a deformable seal member 32. Once this seal member has been brought into contact with a food product, the vacuum gripper is operable to draw air out of a vacuum chamber which is closed by the engagement between the seal member and the food product, thereby drawing the food product against the end gripper.

The end gripper is mounted on a support arm 34, which is in turn fixed to a carriage 36. The carriage is able to reciprocate along parallel guide rails 38 and this motion is driven by a pneumatic cylinder 40. The location of the carriage 36 in the vertical direction, perpendicular to the guide rails 38, is adjustable using an actuator 42. This may be a linear actuator and may be driven by an electric motor for example. Alternatively, the actuator may be hydraulically or pneumatically driven.

FIGS. 3 to 5 illustrate use of the end gripper positioning assembly to control the location of the end gripper relative to a feed conveyor 12. A food product carried through the machine by the feed conveyor travels along the flow path having a central reference line 44. In FIG. 3, the end gripper 30 is disposed at a position spaced laterally from the feed conveyor, outside the flow path, adjacent to an upstream end 46 of the feed conveyor.

In the configuration shown in FIG. 4, the end gripper carriage 36 has moved laterally along the pair of guide rails 38. As a result, the end gripper 30 has been moved laterally into the product flow path. In operation of the processing system, an end gripper will be moved into this position as soon as the next food product to be gripped has moved past the end gripper. The end gripper may then be brought into engagement with the trailing end of a food product, by moving the end gripper along the flow path.

In examples where the food products travel along the flow path in alignment with the central reference line 44, the end gripper may be moved to the same lateral location for each food product. In other examples the lateral location of the food products may vary, in which case the end gripper positioning assembly may be able to adjust the position it is moved to in the flow path in order to centre the end gripper laterally in relation to each food product.

FIG. 5 shows a further configuration in which the end gripper has travelled along the flow path to be located above a downstream end 48 of the feed conveyor 12. The end gripper positioning assembly is mounted for movement in this direction along guide rails (50 shown in FIG. 1) which extend parallel to the flow path and central reference line 44.

The feed conveyor 12 includes a shear edge 49 next to its downstream end 48 to provide a shearing surface for the blade 20 to act against during each cut.

FIGS. 6 and 7 are end views of the transport system 11. The configuration shown in FIG. 6 corresponds to that of FIG. 3, with the end gripper in a position which is spaced laterally from the flow path. The configuration shown in FIG. 7 corresponds to that of FIGS. 4 and 5, with the end gripper 30 located in the flow path. As noted above, actuator 42 is operable to adjust the height of the end gripper. FIG. 7 shows in dashed outline a second, higher position for the end gripper, labelled 30′. In this second position, the end gripper is spaced further from the upper surface of the feed conveyor 12.

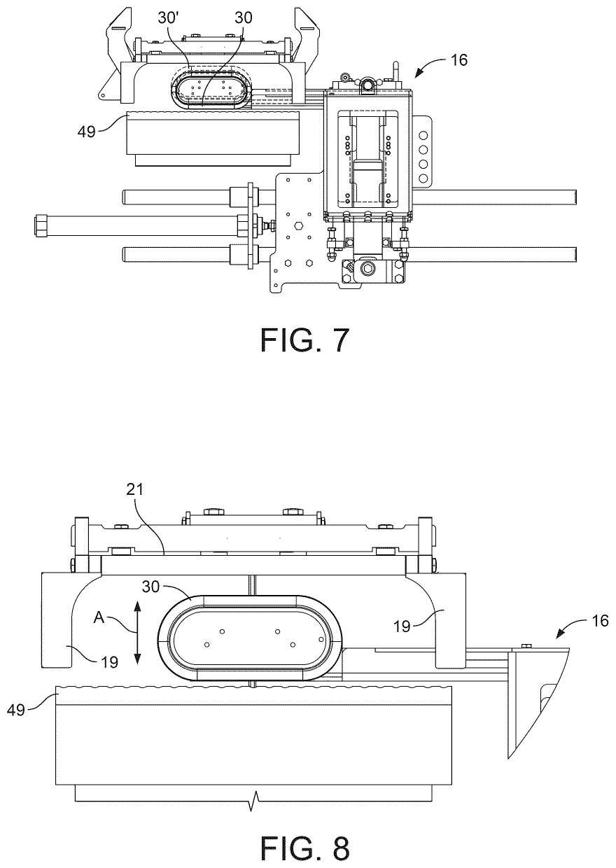

FIG. 8 shows an enlarged view of the region of FIG. 7 containing the end gripper 30, with the direction of the height adjustment for the end gripper indicated by arrow A, perpendicular to the plane of the upper surface of the feed conveyor 12. As shown in FIG. 8, the transport system 11 may also include a top guide 21 for engaging with an upper surface of the food product as it travels along the flow path.

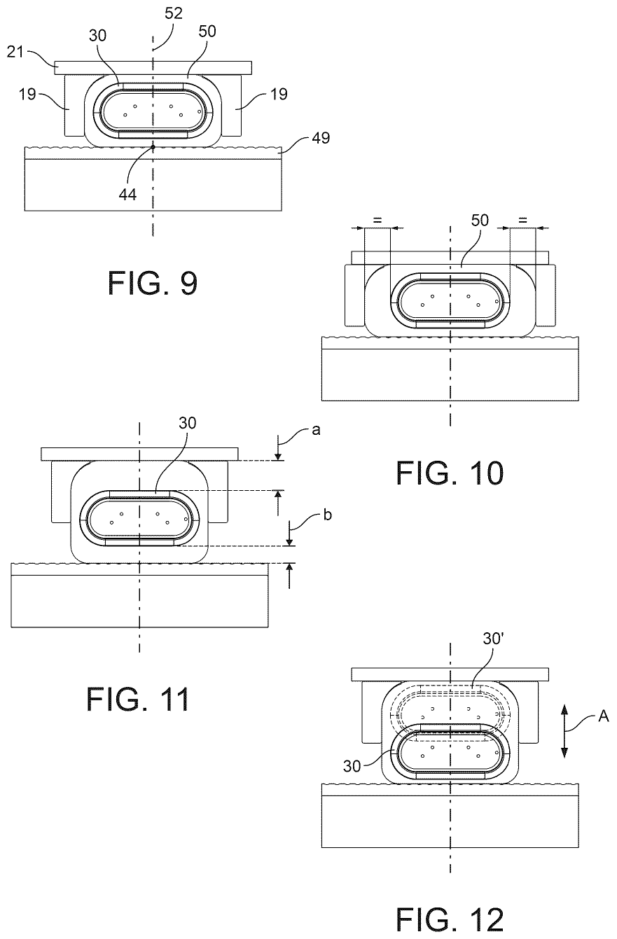

FIGS. 9 to 12 schematically illustrate location of an end gripper 30 relative to a food product 50 resting on a feed conveyor 12. Different end gripper sizes may be chosen to suit different product types. When using a vacuum gripper, the profile of the end gripper in the vertical plane should be spaced inwardly from the minimum product profile in that plane for the product type or batch to be processed, to ensure a sufficient hold on the product can be achieved. It is important for the seal of the gripper to make good contact with the end of the food product all the way around its circumference to ensure that an air-tight interface can be formed.

The food product shown in FIG. 9 has a relatively small cross-sectional area. The food product is located in the lateral direction (in the plane of the drawing) such that its upward centre line coincides with a central reference line 52 of the processing system, which is perpendicular to the plane of the upper surface of the feed conveyor 12 and intersects with the longitudinal central reference line 44 of the system. The food product is located laterally by the side guides 19. The end gripper is also centred on the reference line 52 and so the end gripper is aligned laterally with the centre of the food product. Furthermore, the end gripper is centred on the food product in the vertical direction, such that it is equally spaced from the upper and lower surfaces of the food product. With a food product having a relatively small cross-sectional area, centring the end gripper both horizontally and vertically in this manner maximises the ability of the gripper to obtain a reliable hold on the food product.

FIG. 10 shows a similar end view to that FIG. 9, but in this example the food product 50 has a greater width. Again, the food product and end gripper are located centrally with reference to the vertical central reference line 52. It can be seen that the end gripper is spaced equally from each of the side surfaces of the food product, as indicated by the dimensions labelled “=” in the figure.

In FIG. 11, another example is shown, in which the food product has a greater height. In these circumstances, it may be desirable to space the end gripper equally from the upper and lower surfaces of the food product, as is the case in the examples of FIGS. 9 and 10. Alternatively, it may be advantageous for the end gripper to be unequally spaced from these surfaces. In the example of FIG. 11, it can be seen that the end gripper is spaced a greater distance “a” from the upper surface of the food product in comparison to its distance “b” from the lower surface. The ability to vary the height of the end gripper in relation to the food product and the feed conveyor 12 is also illustrated in FIG. 12, with the direction of height adjustment labelled “A”.

The ability of the food processing system to adjust the height of the end gripper as described herein enables selection of a height which is optimised for each product type, or from product-to-product. For example, it has been determined that in some circumstances it may be advantageous for the end gripper to be located higher on the food product, closer to its upper surface in the vertical direction than its lower surface. This may provide better control over the food product by the end gripper in a system including a cutter which acts generally downwardly on the food product during each cut.

The engagement height may be calculated by the electronic control system in response to the position signal from the electronic position sensor. For example, the electronic control system may calculate the height of the midpoint of the food product as half of the height determined from the position signal and then adjust the midpoint height by a predetermined percentage or a distance to provide the engagement height.

In examples of food processing systems according to the present disclosure, a product engaging component is provided for engaging with an upper surface of a food product lying on a support surface in the system. This component may be in the form of at least one side guide 19 which also engages at least part of an upper surface of a food product. In other implementations, the product engaging component may be a top guide 21 of the transport system. The top guide may only engage with an upper surface of the food product. In a further variation, a top guide and at least one side guide may be connected together so that they are moved together into engagement with a food product and form the product engaging component.

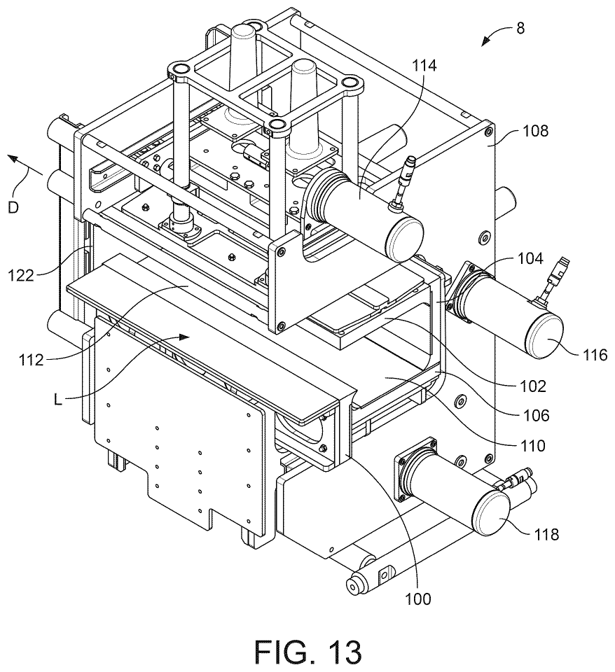

Furthermore, the product engaging component may be a die of a forming module 8 of the system which engages an upper surface of a food product as the forming module shapes a food product. An example of a forming module 8 is shown in FIG. 13, in which top die 102 may embody a product engaging component.

The forming module comprises four dies, namely a front side die 100, a top die 102, a rear side die 104 and a lower die 106. The dies are carried by a supporting framework 108 and arranged to receive a food product in a food product receiving chamber 112.

The forming module may be used in combination with an end pusher which engages the trailing end of the food product whilst it is in the forming module. The end pusher may flatten the trailing end to some extent, which can be beneficial when using a vacuum gripper as a flatter end face may more readily form a good seal with the vacuum gripper.

Each die is mounted on the supporting framework 108 in such a way as to be movable transversely with respect to the flow path which extends in direction D. A first drive 114 (which may be a servo motor) is provided for moving the upper die 102 vertically, towards and away from the lower die 106. A second drive 116 is operable to move the rear side die 104 and the top die 102 horizontally towards and away from the front side die 100. A third drive 118 is arranged to move the front side die 100 and the lower die 106 horizontally.

The forming module is arranged to receive a food product along a transverse direction, in loading direction “L”, into the receiving chamber 112. As shown in FIG. 13, a transverse side of the chamber is opened to receive a food product by lowering the front side die 100.

It will be appreciated that an electronic position sensor able to generate a position signal dependent on the height of the product engaging component above a support surface of the food processing system may take various forms. For example, electro-optical sensors such as laser displacement sensors may be used to monitor displacement of a product engaging component. A sensor may be linked to a mechanism used to govern the height of the product engaging component. For example, a drive motor associated with the product engaging component may be a servomotor which includes a position encoder.

The position encoder may therefore provide a suitable electronic position sensor for use in generating a position signal dependent on the height of the product engaging component.

The position signal generated by the electronic position sensor is transmitted to an electronic controller of the food processing system. In the example shown in FIG. 1, the electronic controller may be the electronic control system 5.

It will be appreciated that references herein to perpendicular or parallel relative orientations and the like are to be interpreted as defining perpendicular or parallel relationships between components within practical tolerances.

The following enumerated paragraphs represent illustrative, non-exclusive ways of
describing examples according to the present disclosure.

A. A food processing system for cutting a food product into portions, the system comprising:
a cutter configured to cut portions from a leading end of an elongate food product;
a transport system configured to transport a food product along a product flow path to the cutter, wherein the transport system comprises an end gripper configured to grip a trailing end of a food product lying on a product support in the flow path, and an end gripper positioning assembly configured to control the location of the end gripper and bring the end gripper into engagement with a food product at an engagement height above the product support;
a product engaging component configured to engage an upper surface of a food product lying on a support surface in the system;
an electronic position sensor configured to generate a position signal dependent on the height of the product engaging component above the support surface; and
an electronic controller configured to receive the position signal and to control the engagement height of the end gripper using the end gripper positioning assembly with reference to the position signal.

A1. A system of paragraph A, wherein the product engaging component is a guide member located above the support surface to guide the food product as it travels along the product flow path towards the cutter.

A2. A system of paragraph A, wherein the electronic controller is configured to bring the end gripper into engagement with the food product whilst the product engaging component is in engagement with the food product.

A3. A system of paragraph A or A2, wherein the product engaging component is a die of a forming module of the system, and the die is employed in the forming module to engage an upper surface of a food product.

A4. A system of paragraph A, wherein the product engaging component is a drive belt or track.

A5. A system of any one of paragraphs A to A3, wherein the electronic controller is configured to set the engagement height to be such that a region of a food product engaged by the end gripper is unequally spaced from the upper and lower surfaces of the food product.

A6. A system of any preceding paragraph, wherein the end gripper positioning assembly comprises an actuator configured to adjust the height of the end gripper under the control of the electronic controller.

A7. A system of any preceding paragraph, wherein the end gripper positioning assembly includes a carriage mounted on at least one guide, with the carriage movable between first and second locations on the guide, such that when the carriage is at the first location, the end gripper is spaced laterally from the product flow path, and when the carriage is at the second location, the end gripper is in the product flow path.

A8. A system of any preceding paragraph, wherein the end gripper positioning assembly comprises an actuator configured to adjust the height of the end gripper under the control of the electronic controller, the end gripper positioning assembly includes a carriage mounted on at least one guide, with the carriage movable between first and second locations on the guide, such that when the carriage is at the first location, the end gripper is spaced laterally from the product flow path, and when the carriage is at the second location, the end gripper is in the product flow path, and wherein the actuator is carried by the carriage.

A9. A system of paragraph A, wherein the end gripper positioning assembly includes a carriage mounted on at least one guide, with the carriage movable between first and second locations on the guide, such that when the carriage is at the first location, the end gripper is spaced laterally and horizontally from the product flow path, when the carriage is at the second location, the end gripper is in the product flow path.

A10. A system of paragraph A, wherein the end gripper is a vacuum gripper.

A11. A system of any preceding paragraph, wherein the actuator is carried by the carriage.

A12. A system of paragraph A8 when dependant on paragraph A7, wherein the actuator is carried by the carriage.

A13. A system of paragraph A8 or paragraph A9 when dependant on paragraph A8, wherein when the carriage is at the first location, the carriage is spaced horizontally from the product flow path.

B. A method of operating a food processing system for cutting a food product into portions, wherein the system includes an end gripper configured to grip a trailing end of a food product lying on a product support, the method comprising the steps of:
bringing a product engaging component into engagement with an upper surface of a food product lying on a support surface of the system; detecting the height of the product engagement component above the support surface and generating a position signal dependent on the detected height;
receiving the position signal in an electronic controller; and
controlling with the electronic controller the engagement height of the end gripper above the product support at which the end gripper is brought into engagement with a food product with reference to the position signal.

C. A method of operating a food processing system of any of paragraphs A to A13, the method comprising the steps of:
bringing the product engaging component into engagement with an upper surface of a food product lying on the support surface of the system;
detecting the height of the product engagement component above the support surface and generating a position signal dependent on the detected height; and
adjusting the engagement height of the end gripper using the end gripper positioning assembly with reference to the position signal.

1. A food processing system for cutting a food product into portions, the system comprising:
a cutter configured to cut portions from a leading end of an elongate food product;
a transport system configured to transport a food product along a product flow path to the cutter, wherein the transport system comprises an end gripper configured to grip a trailing end of a food product lying on a product support in the flow path, and an end gripper positioning assembly configured to control the location of the end gripper and bring the end gripper into engagement with a food product at an engagement height above the product support;
a product engaging component configured to engage an upper surface of a food product lying on a support surface in the system;
an electronic position sensor configured to generate a position signal dependent on the height of the product engaging component above the support surface; and
an electronic controller configured to receive the position signal and to control the engagement height of the end gripper using the end gripper positioning assembly with reference to the position signal.

2. The system of claim 1, wherein the product engaging component is a guide member located above the support surface to guide the food product as it travels along the product flow path towards the cutter.

3. The system of claim 1, wherein the electronic controller is configured to bring the end gripper into engagement with the food product whilst the product engaging component is in engagement with the food product.

4. The system of claim 1, wherein the product engaging component is a die of a forming module of the system, and the die is employed in the forming module to engage an upper surface of a food product.

5. The system of claim 1, wherein the product engaging component is a drive belt or track.

6. The system of claim 1, wherein the electronic controller is configured to set the engagement height to be such that a region of a food product engaged by the end gripper is unequally spaced from the upper and lower surfaces of the food product.

7. The system of claim 1, wherein the end gripper positioning assembly comprises an actuator configured to adjust the height of the end gripper under the control of the electronic controller.

8. The system of claim 1, wherein the end gripper positioning assembly includes a carriage mounted on at least one guide, with the carriage movable between first and second locations on the guide, such that when the carriage is at the first location, the end gripper is spaced laterally from the product flow path, and when the carriage is at the second location, the end gripper is in the product flow path.

9. The system of claim 8, wherein the actuator is carried by the carriage.

10. The system of claim 8, wherein when the carriage is at the first location, the carriage is spaced horizontally from the product flow path.

11. The system of claim 1, wherein the end gripper is a vacuum gripper.

12. A method of operating a food processing system for cutting a food product into portions, wherein the system includes an end gripper configured to grip a trailing end of a food product lying on a product support, the method comprising the steps of:
bringing a product engaging component into engagement with an upper surface of a food product lying on a support surface of the system;
detecting the height of the product engagement component above the support surface and generating a position signal dependent on the detected height;
receiving the position signal in an electronic controller; and
controlling with the electronic controller the engagement height of the end gripper above the product support at which the end gripper is brought into engagement with a food product with reference to the position signal.

13. A method of operating a food processing system of claim 1, the method comprising the steps of:
bringing the product engaging component into engagement with an upper surface of a food product lying on the support surface of the system;
detecting the height of the product engagement component above the support surface and generating a position signal dependent on the detected height; and
adjusting the engagement height of the end gripper using the end gripper positioning assembly with reference to the position signal.
